(19) United States
(12) Patent Application Publication
(10) Pub. No.: US 2011/0113689 A1
(43) Pub. Date: May 19, 2011

(54) System And Method For Powering A Movable Barrier Operator

(76) Inventor: Keith R. Johnson, Orland Park, IL (US)

(21) Appl. No.: 12/619,035

(22) Filed: Nov. 16, 2009

(51) Int. Cl. E05F 15/20

(52) U.S. Cl. 49/31

(57) ABSTRACT

A voltage is supplied at an output of a switched mode power supply to a component of the movable barrier operator system. A change in a current being supplied to the component of the movable barrier operator system is sensed by the current sensing circuit. A change in the voltage being supplied at the output of the switched mode power supply is responsively effectuated based at least in part upon the change in the current sensed by the current sensing circuit.

### FIELD OF THE INVENTION

The field of the invention relates to movable barrier operators systems and, more specifically, to powering movable barrier operator systems.

### BACKGROUND

Power supplies are typically used in electrical systems to supply varying amounts of voltage, current and power to various electrical or electronic components or devices. In one example, power supplies transform initial values of voltage, current and power to other values for use by the electrical components of a system.

Over the years, various types of power supplies have been used in movable barrier operator systems. For instance, transformer-based systems have been used. In transformer-based systems, a transformer transforms an input voltage from a first (usually high) voltage to a second (usually lower) voltage. The transformed voltage is used to drive the motor of the barrier operator. Unfortunately, in these systems the output voltage supplied to the motor is highest when the motor is operating in an idle state. Consequently, more voltage is drawn by the motor than is really needed thereby leading to wasted power and inefficient operation of the motor. Transformer-based systems also tend to be large in size leading to difficulties in installing them in environments where space is at a premium.

In supplying power to moveable barrier operators which move barriers, gates and doors, such as garage doors, electronic controls and features, such as clocks, thermometers, and status indicators operated by electronic devices which are associated with the moveable barrier operators require low amounts of current and voltages. In contrast motors which power the barrier or door and other features require higher currents and voltages which if supplied to the electronic controls and other electronic devices would be energy inefficient and could deleteriously harm the electronic control and/or electronic device. In the past transformers have been used to address these problems, but as described above transforms or have their highest voltage when in an “idle” state where the only utilization of the voltage and low current demand is by the electronic controls and other electronic devices which provide features additional to driving a door or barrier with a motor.

In another approach, switched-mode power supplies have also been used in conjunction with movable barrier operator systems. In using a switched-mode power supply, a constant output voltage is maintained as the current drawn by a load (i.e., the motor of the barrier operator) increases. Unfortunately, the voltage never changes significantly with the current and the same amount of power is supplied to the motor regardless of whether the motor is not operating or other features are in an in an idle mode or the motor is in a normal operational running mode. As with transformer-based power supplies, this switched-mode power supply operating pattern leads to wasted power and inefficient operation of the motor during modes of operation where little power is needed.

### SUMMARY

An apparatus and method are provided where the voltage and/or current supplied to a moveable barrier operator component such as a motor can be varied depending upon the operating characteristic or mode of operation of devices which are a part of a moveable barrier operator system where some of the devices, such as a motor, require higher voltages and current (hereinafter an “operational mode device”), but other devices associated with operation of the moveable barrier operator are in an “idle state” (hereinafter an “idle mode device”) and require low voltages and currents. The apparatus and method described herein control how much power is needed to operate the moveable barrier operator during an operational state versus and idle state. In one aspect, the method and apparatus supply varying voltage and current depending upon the demands of the system. With the apparatus and method described herein, when the motor is not operating and not moving a barrier or the moveable barrier operator is in an idle mode or state, the voltage (and/or current) being supplied by the power supply is less, but is sufficient to operate electronic controls and low voltage, low current requiring devices, such as electronic devices. With the apparatus and method described herein, when more power and/or current are required in an operational state, more voltage (and/or current) is supplied to operate a moveable barrier component, such as a motor to open or close a barrier. In so doing, the efficiency of the moveable barrier operator is increased as compared to previous apparatuses and systems, less voltage, current, and power are consumed, and barrier operator operational costs are reduced.

In an important aspect, a switched mode power supply at its output supplies voltage to a component, such as an operational mode device, demanding higher voltages and currents as well as to a low voltage low current requiring idle component, such as an idle mode device. The switched mode power supply may include, for example, an input rectifier and filter section, an inverter section, an output transformer and rectifier section, and a regulator section. The input rectifier section converts a received AC line voltage to a DC voltage. This section filters out noise or other unwanted characteristics from the received signal. The inverter section converts the DC back to AC. The output transformer and rectifier section include a transformer that isolates the input from the output. A filter may be used to smooth the resulting waveform. The regulator section monitors the output voltage and compares it with a reference voltage. In the absence of adjustments made to the regulator (or feedback) section, the regulator section acts to set the voltage to a predetermined desired output. With the approaches described herein the operation of the regulator section is adjusted to account for the operation of the movable barrier operator operational mode or idle mode devices which are a part of the moveable barrier operator. It will be appreciated that the above-mentioned elements of the switched mode power supply are examples only and that other elements or combinations of elements may be used to implement the switched-mode power supply to vary the voltage and current as described herein.

With the apparatus and method described herein, a current sensing circuit senses a change in a current being supplied to the components under the idle or operational state of the movable barrier operator system. A change in the voltage being supplied at the output of the switched mode power supply is responsively effectuated based at least in part upon the change in the current sensed by the current sensing circuit. In this regard, a plurality of resistors may be provided to sense the current. The operation of an opto-isolator can be used to vary the operation of the feedback section of the switched mode power supply and thereby vary the voltage, current, and/or power supplied at the output of the power supply.

A component may be an operational mode device or an idle mode device and may be a variety of components of the moveable barrier operator and/or connected to the operator. For example, the component may be an operational mode device such as a motor, sensing element (e.g., motion sensor, obstruction sensor), switching element (e.g., light switch, keypad), lighting element (e.g., lamp), or an idle mode device such as an electronic component that uses power from the power supply (e.g., microprocessor, control board). In this respect a component may be external to the housing of the movable barrier operator (e.g., a light bulb) or internal to the housing of the movable barrier operator (e.g., a motor).

In one aspect, the change in current indicates that the movable barrier operator system is changing from a first mode of operation, such as the idle mode, to a second mode of operation, such as the operational mode. Different modes of operation of the movable barrier operator component utilize different voltage or current levels. In one example, the first mode of operation is an idle mode of operation which requires less voltage and/or current and the second mode is an operational mode of operation which requires more voltage and/or current. Additional modes of operation with varying voltage (and current) requirements are possible.

The voltage produced by a switched mode power supply may be changed in a variety of different ways and according to different patterns. For example, a feedback voltage ratio associated with the switched mode power supply may be changed, which changes the voltage. Alternatively, a first voltage is produced when a first current is sensed and second voltage is produced when a second current is sensed and the first voltage lower than the second voltage and the first current lower than the second current.

The current sensing circuit may be constructed of various types of electrical components. For example, the current sensing circuit may include a plurality of resistors that are connected in parallel. In other examples, the current sensing circuit comprises one or more active electrical components such as transistors.

The change of mode of operation can be indicated and determined by a variety of different conditions present in the system. For example, the amount of current drawn by the moveable barrier operator component may be monitored and a determination may be made as to when the detected amount of current drawn by the moveable barrier operator component falls below a predetermined threshold. When the current falls below a certain level, a change in the mode of operation of the movable barrier operator is executed.

In another aspect, a voltage is controlled in a moveable barrier operator system which comprises a switched mode power supply and a sensing circuit. A voltage is supplied at an output of the switched mode power supply to a component of the movable barrier operator system. A change is sensed in a characteristic being supplied to a component of the movable barrier operator system at the sensing circuit. The characteristic can be a variety of characteristics such as a voltage, a current and a power, to name a few examples. A change is responsively effectuated in the voltage being supplied at the output of the switched mode power supply to the component based at least in part upon the change in the characteristic sensed by the sensing circuit.

In yet another aspect, a movable barrier operator includes an electronic barrier control apparatus which controls the motor, and optionally, additional operational mode devices of the moveable barrier operator and an electronic component which effects low or high voltage operations of the moveable barrier operation other than to effect movement of the barrier. The motor is coupled to and controlled by the electronic control apparatus and may include a sensing element, a switching element, or a lighting element. The electronic element may control a lighting element, a clock, or a thermometer, or may effect the operation of an idle mode device to name a few examples. The operations of the operational and electronic components draw a varying amount of a first electrical quantity from a switched mode power supply. The switched mode power supply adjusts the varying amount of the first electrical quantity supplied to the movable barrier operator based upon sensing changes in a second electrical quantity drawn by the component from the switched mode power supply. The electrical quantity may be a wide variety of electrical quantities such as a voltage, a current, and a power.

Thus, approaches are provided where the voltage supplied to a moveable barrier operator component is varied according to the needs of the component (e.g., a motor). For instance, when the motor is operating in an idle mode, the voltage supplied by the power supply is less than in a normal running mode when more voltage is required. In so doing, the efficiency of the moveable barrier operator is increased, less voltage and power are consumed, and the barrier operator costs less to operate.

### BRIEF DESCRIPTION OF THE DRAWINGS

FIG. 1 comprises a block diagram of a system for powering a movable barrier operator according to various embodiments the present invention;

FIG. 2 comprises a circuit diagram of one example of a system for powering a movable barrier operator according to various embodiments of the present invention;

FIG. 3 comprises a flow chart of one approach for powering a movable barrier operator according to various embodiments of the present invention;

FIG. 4 comprises a voltage current curve showing the management of voltage provided to a movable barrier operator according to various embodiments of the present invention where the change is discrete

FIG. 5 comprises a voltage current curve showing the management of voltage provided to a movable barrier operator according to various embodiments of the present invention where the change is continuous;

FIG. 6 comprises a movable barrier operator according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DESCRIPTION

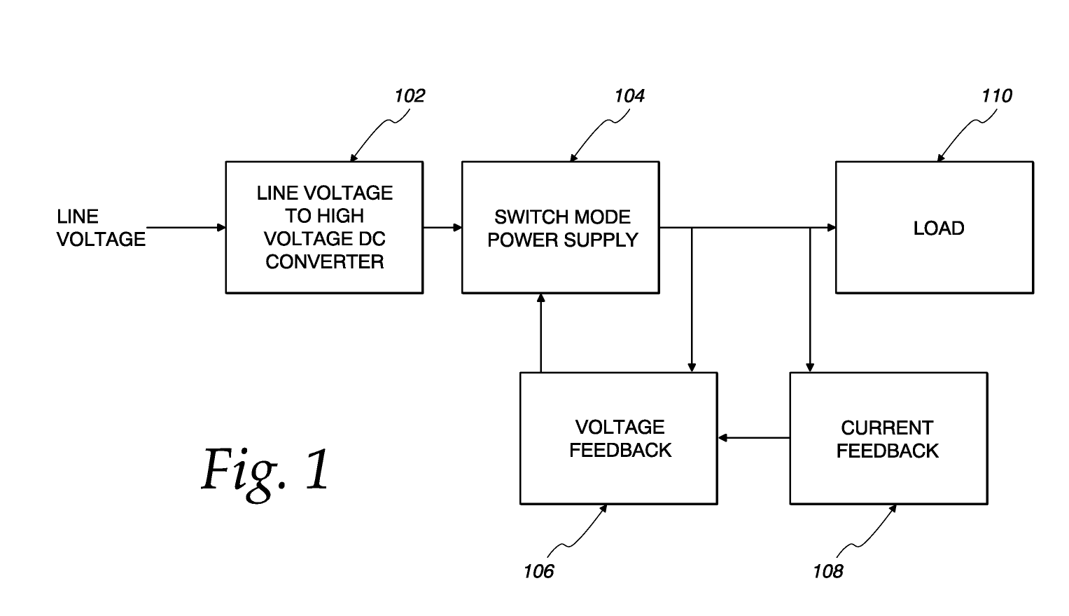

Referring now to FIG. 1, one example of a system for powering a movable barrier operator is described. The system includes a line voltage-to-high voltage AC-to-DC converter 102, a switched mode power supply 104, a voltage feedback network 106, a current feedback network 108, and a load 110. These various elements may be constructed of active electronic components (e.g., transistors or diodes that control voltages and currents) or passive components (e.g., resistors or capacitors that do not control voltages or currents).

The line voltage-to-high voltage AC-to-DC converter 102 converts a high AC line voltage (e.g., 120 volts AC) to a high voltage DC voltage (e.g., 170 V DC). The switched mode power supply 104 converts the high voltage low current by transferring small amounts of energy across the circuit (e.g., via a transformer). In one example, the power supply 104 is a fly back switched mode power supply. Other types of switched mode power supplies may also be used.

The voltage feedback network 106 regulates the output voltage of the power supply 104. In one example, the power supply 104 uses an opto-isolator to control the operation of the switched mode power supply. Various approaches may be used to control the regulation point of the voltage feedback network 106. In one example, the voltage present across a pair of resistors may be adjusted to alter the voltage regulation point.

The current feedback network 108 measures the current at the output of the switched mode power supply. Based upon the magnitude of the current, the current feedback network 108 alters the operating characteristics of the voltage feedback network 106, which, in turn, alters the operating characteristics of the switched mode power supply 104.

A load 110 is connected to the output of the switched mode power supply 104. The load 110 may be a motor or the other components of a movable barrier operator. The load 110 draws relatively large amounts of current when moving a barrier and relatively smaller amounts of current when the barrier is not being moved.

The load 110 may be a variety of components of or connected to the operator. For example, the component may be an operational mode device such as a motor, sensing element (e.g., motion sensor, obstruction sensor), switching element (e.g., light switch, keypad), lighting element (e.g., lamp), or an idle mode device such as an electronic component that uses power from the power supply (e.g., microprocessor, control board). In this respect a component may be external to the housing of the movable barrier operator (e.g., a light bulb) or internal to the housing of the movable barrier operator (e.g., a motor).

The components may draw a various amounts of voltage, current, and power. In one example, the idle mode device draws 0.5 amps of current or less. In another example, the operational mode device draws 20 volts of voltage or more. In yet another example, the operational mode device draws a current of 3 or more amps. Other values of voltage, current, and power are possible.

In operation, the voltage at the output of the switched mode power supply 104 is lowered by the operation of the voltage feedback network 106 and the current feedback network 108 when little current is being drawn by the load 110. More specifically, the feedback ratio of the voltage feedback network 106 is adjusted to lower the voltage output when little current is being drawn by the load 110. This allows a low voltage and low current to be supplied to the load 110 when low current is being drawn by the load 110. Conversely, the voltage is adjusted to a higher value when more current is being drawn by the load 110. In so doing, the efficiency of the system is maximized since a low voltage is provided to the load in idle mode while a higher voltage is provided to the load as needed. Consequently, power is not wasted by the load 110 in modes of operation where high power is not required.

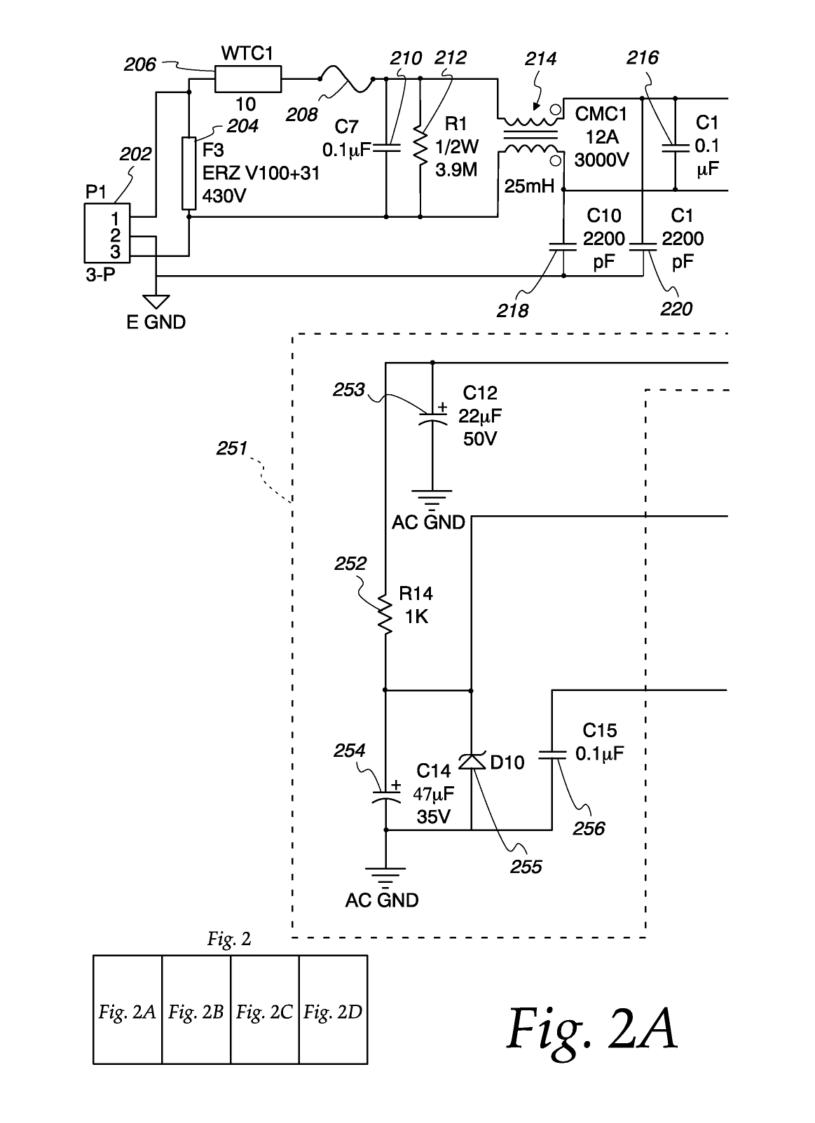

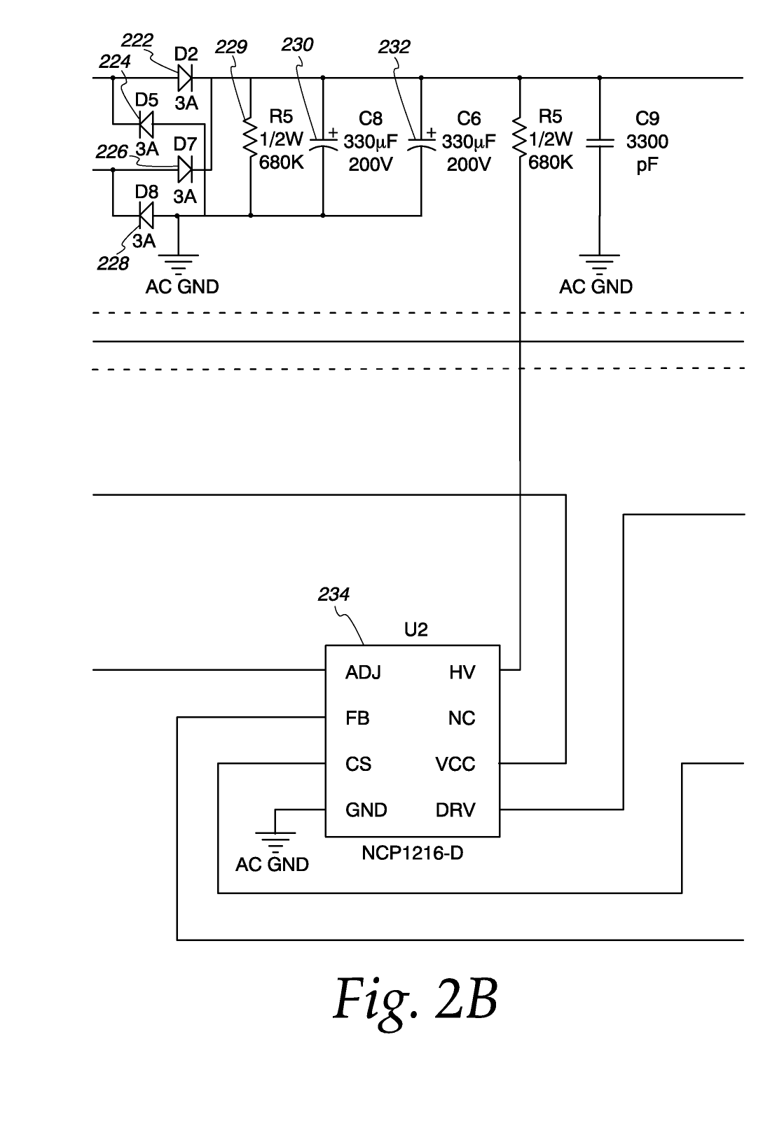

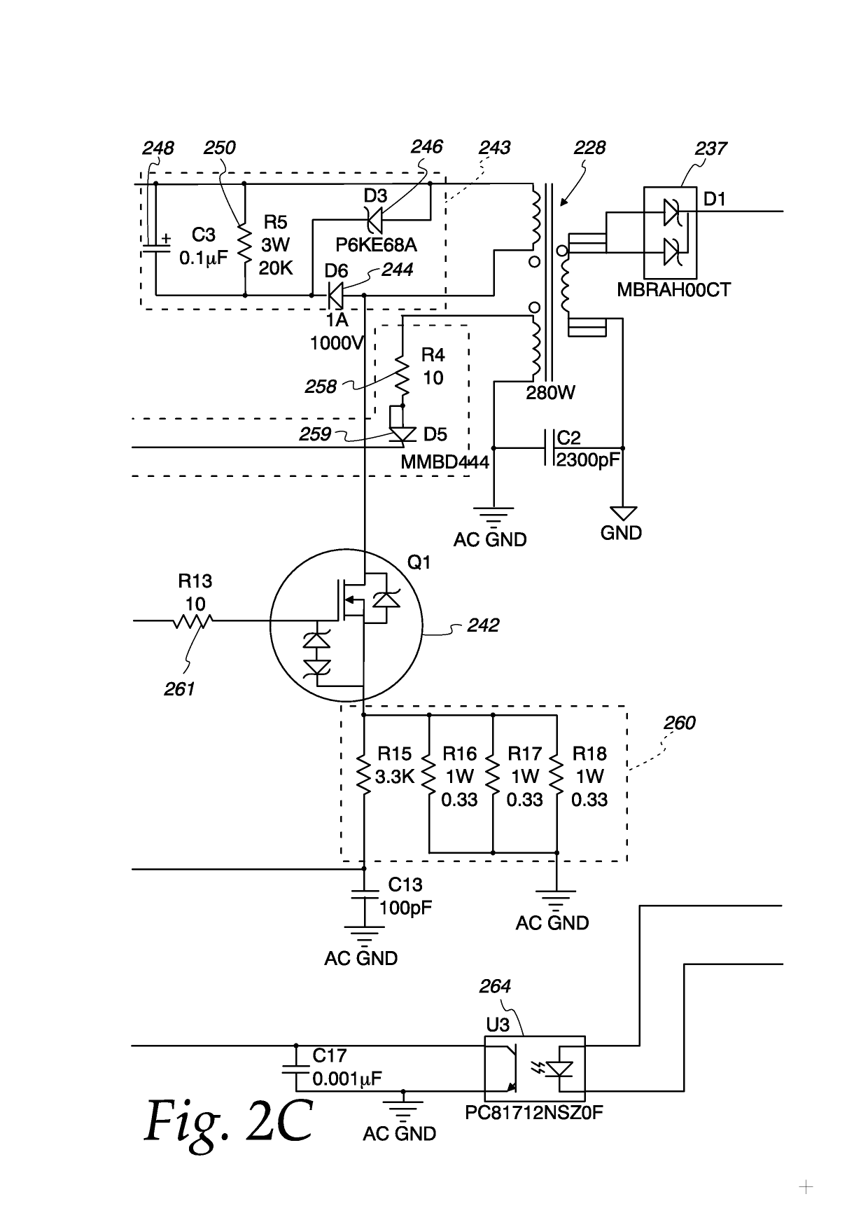

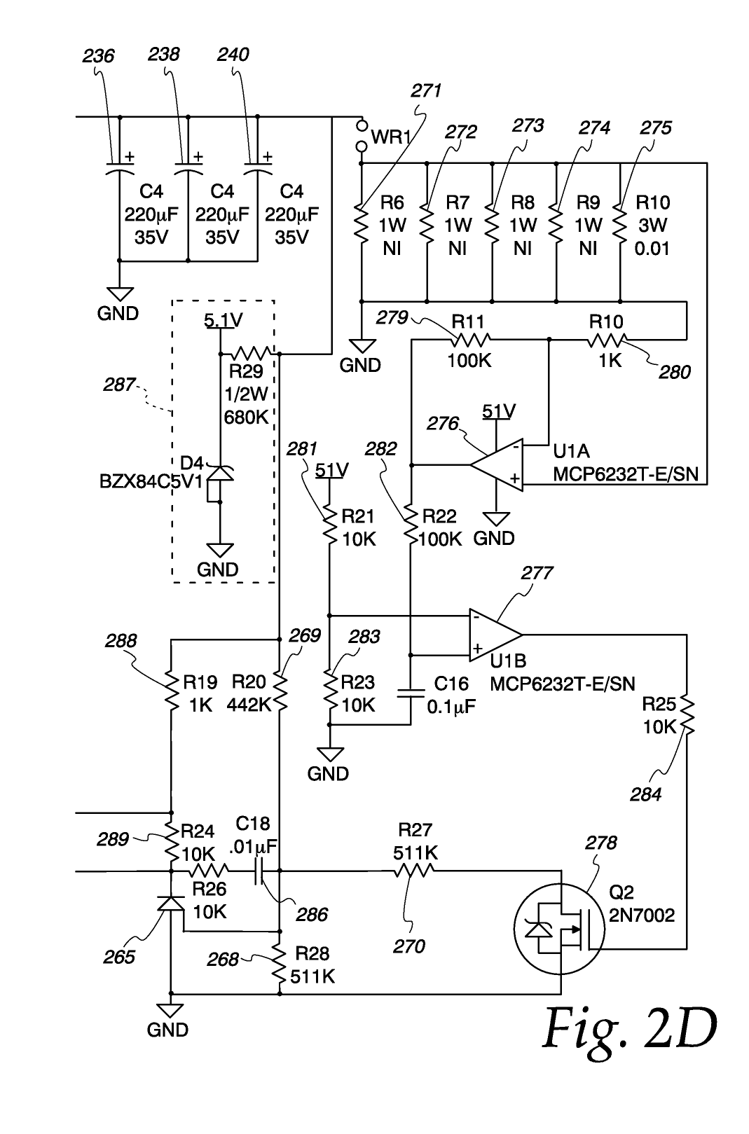

Referring now to FIG. 2, one example of a system for voltage and current regulation is described. Power is input into the system at a power connector 202 (also labeled as P1). The power may be input from a mains voltage supply, for example, a 120 VAC power supply. The input power and voltage pass through a first protection device 204 (also labeled as F3), a second protection device 206 (also labeled as NTCI) and a fuse 208 (also labeled as F9). The first protection device 204 may be a metal oxide varistor (MOV) overvoltage protection device and, in one example, is a ERZ-V10D431 surge protector manufactured by Panasonic, Inc. The second protection device 206 may be any Negative Temperature Coefficient (NTC) thermistor that provides over current protection. The fuse 208 may be any standard fuse as is known to those skilled in the art. These protection devices protect against high of currents or voltages that may damage other components of the system.

The fuse 208 is coupled to a capacitor 210 (also labeled as c7), a resistor 212 (also labeled as R1), and a transformer 214. In one example, the capacitor is 0.1 micro farads and the resistor is 3.9 M ohms. A capacitor 216 (e.g., 0.1 micro farads), a capacitor 218 (e.g., 2200 pico farads), and a capacitor 220 (e.g., 2200 pico farads) are coupled to the opposite side of the transformer 214.

Together, these elements reduce or eliminate common mode noise in the system and provide a common mode choke function. In other words, these elements filter the voltages so that electromagnetic interference (EMI) is not passed back through to the mains power supply (in one direction) or through to the remainder of the circuit (in the opposite direction).

A diode bridge includes diodes 220 (also labeled as D2), diode 222 (also labeled as D5), diode 224 (also labeled as D7), and diode 226 (also labeled as D8). Together, these diodes convert the AC voltage received from the mains power supply to a DC voltage. The diode bridge is connected to a second transformer 228.

The diode bridge is also coupled to a resistor 229 (also labeled as R3), a capacitor 230 (also labeled as capacitor C8) and a capacitor 232 (also labeled as C6). Energy is stored in the capacitors 230 and 232, which in this example are 330 micro farad capacitors. Excess energy is discharged by the resistor 229, which in this example is 20 k ohms. Together these elements control energy/current and/or voltage ripple in the system. At the output of the diode bridge, a voltage of approximately 170 volts DC is created in one example.

A controller 234 (also labeled as U2) is used to activate and deactivate the second transformer 228. In one example, the controller 234 is a NCP1216-D controller chip manufactured by ON Semiconductor corporation. The controller 234 switch portions of voltage or energy across the second transformer 228 to be stored in capacitors 236 (also labeled as C4), 238 (also labeled as C5), and 240 (also labeled as C19) via diodes 237. The controller 234 controls the operation of a transistor 242 (also labeled as Q1). The transistor 242 is turned on and off to pulse energy across the second transformer 228. When the transistor 242 is activated, energy flows across the transformer 228 and when the transistor 242 is deactivated, energy does not flow across the second transformer 228.

An overvoltage protection circuit 243 includes a diode 244 (also labeled as D6), a diode 246 (also labeled as D3), a capacitor 248 (also labeled as C3), and a resistor 250 (also labeled as R2). The overvoltage protection circuit 243 protects the transistor 242 from damage during the on/off cycling by preventing an overvoltage condition from occurring at the transistor 242.

In the present example, the controller 234 is powered at least partially by power that is tapped from the transformer 228. The power is supplied from the transformer 228 via a boot strap circuit 251. The boot strap circuit 251 includes a resistor 252 (also labeled R14), a capacitor 253 (also labeled as C12), a capacitor 254 (also labeled as C14), a diode 255 (also labeled as D10), a capacitor 256 (also labeled as C15), a resistor 257 (also labeled as R15), a resistor 258 (also labeled as R4), and a diode 259 (also labeled as D9). Resistors 260 (also labeled as R15-R18) provide biasing to Q1. A resistor 261 (also labeled as R13) provides for isolation and a capacitor 262 (also labeled as C17) provides for noise control.

An opto-isolator 264 signals to the controller 234 to turn the chip controller 234 on and off. The opto-isolator 264 is controlled by the Terminal adjustable shunt regulator 265 (also labeled as D11). The Terminal adjustable shunt regulator may be a ZTL 431 or ZTL 432 shunt regulator manufactured by Zertex Semiconductor, Inc. to take one example. The terminal adjustable shunt regulator 265 controls the current in the opto-isolator 264. When current flows in the opto-isolator 264, the energy transfer is stopped and the switched mode power supply is effectively disabled. This result occurs because the controller 234 does not allow energy transfer to occur by halting energy transfer across the transformer 228. When no current flows in the opto-isolator 264, the controller 234 is active and pulses the transformer 228 to allow energy pieces to flow across the transformer 228 and into capacitors 236, 238, and 240 (e.g., 2200 micro farad capacitors). When the voltage reaches the limit of the capacitors, the switched mode turns off and the transfer of energy is halted.

The terminal adjustable shunt regulator 265 has a voltage set point and this set point can be adjusted according to the present approaches. Adjustment of the set point affects whether current flows through the terminal adjustable shunt regulator 265 and hence the voltage and current provided at the output of the system.

The voltage set point of the terminal adjustable shunt regulator 265 is adjustable by the ratio of a resistor 268 (also labeled as R28) and a resistor 269 (also labeled as R20). Additionally, a resistor 270 (also labeled as R27) can be added in parallel to alter the set point of the terminal adjustable shunt regulator 265. As mentioned, adding the resistor 270 alters the operating point of the terminal adjustable shunt regulator 265.

Current flows through the opto-isolator 264 (thereby disabling the controller 234 and the switched mode power supply) when the supply voltage is greater than the voltage set point of the terminal adjustable shunt regulator 265. On the other hand, current does not flow (thereby enabling the controller 234 and the switched mode) when supply voltage is less than the set point. And, as mentioned, the set point itself is adjustable.

Whether the resistor 270 is incorporated or not incorporated into the circuit depends upon the current measured by resistors 271, 272, 273, 274, and 275 (also labeled as R6-R10). The voltage that is related to the current measured by these resistors is fed to an amplifier 276 (also labeled as U1A) and then to a comparator 277 that compares the voltage to a preset threshold amount (e.g., 2.5 volts). If the threshold voltage is exceeded, a field effect transistor (FET) 278 is activated and this action adds the resistor 270 to the circuit. The amplification circuit includes a resistor 279 (also labeled as R11) and a resistor 280 (also labeled as R12). The comparator circuit includes a resistor 281 (also labeled as R21), a resistor 282 (also labeled as R22), a resistor 283 (also labeled as R23), and a resistor 284 (also labeled as R25). A resistor 285 (also labeled as R26) and a capacitor 286 (also labeled as C18) are coupled between the output of the terminal adjustable shunt regulator 265 and the resistor 270. A power supply 287 supplies current as directed by the set point through a resistor 288 (also labeled as R19) and a resistor 289 (also labeled as R24).

In one example, of the operation of the system of FIG. 2, when high current is drawn, a high voltage is measured, resistor 270 is in the circuit. No current is in the opto-isolator and the switched mode power supply is active to increase and maintain the voltage presented at the output.

On the other hand, when low current is drawn by the load, low voltage is measured and FET 278 is off. Resistor 270 is incorporated into the circuit. The ratio of the resistors 268 and 269 maintains an operating point such that current flows through the opto-isolator 264 because the supply voltage is greater than the voltage set point. Hence, the opto-isolator 264 is disabled and energy is not being transferred across so the voltage at the output of the circuit is low.

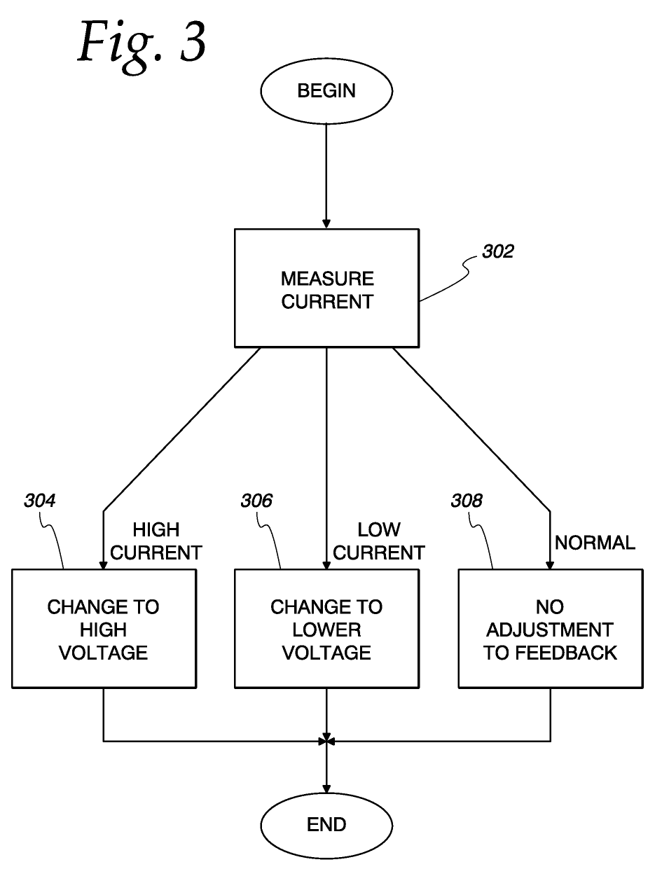

Referring now to FIG. 3, one example of an approach to control the power being applied to a movable barrier operator is described. At step 302, the current is measured at the output of the power supply. This current is an amount that is drawn by the movable barrier operator.

Based upon the measured current, the current may be high or low. If it is high, at step 304, the feedback characteristic is changed if needed to supply a high output voltage. This can be done in many different approaches such as bringing resistors in to and out of the feedback circuit to change the feedback ratio.

If the measured current is too low, then the feedback characteristic may be adjusted to lower the voltage at step 306. For example, resistors may be added into the circuit to lower the voltage.

If the measured current is neither too high nor too low, then the same feedback characteristic is provided at step 308. That is, the feedback ratio is not changed so that the feedback circuit will react as planned. In other words, in the “normal” operating range may be maintained to keep the output voltage steady or adjustments to the voltage may be made as normal but without adjusting the feedback ratio.

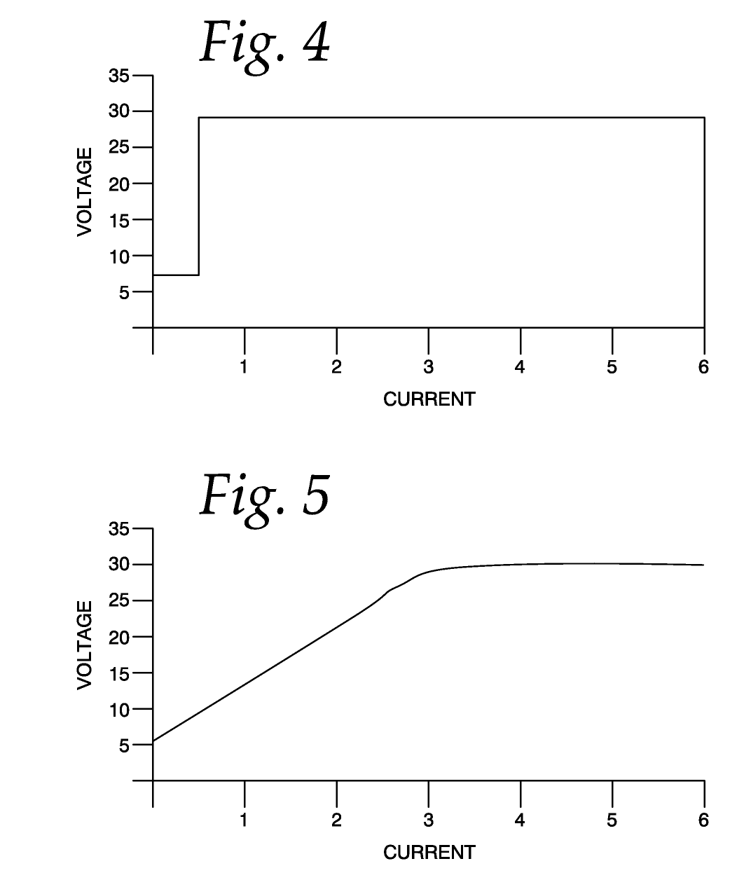

Referring now to FIG. 4, one example of a voltage current characteristic is described. The modification of the feedback network associated with the switched mode power supply causes a low voltage to be supplied when very little current is drawn by the load. This allows the idle mode to have an improved power efficiency. In contrast, higher amounts of current, voltage, and power are supplied to the operator when the operator is moving the barrier. The change in this example is discrete in nature.

Referring now to FIG. 5, one example of a voltage current characteristic supplied to a load (e.g., a motor) is described. As can be seen in FIG. 5, the modification of the feedback network associated with the switched mode power supplies allows a low voltage to be supplied when the current is very low and a larger voltage to be supplied when more current is needed by the load. This allows the idle mode to improve its power efficiency without affecting the operational capacity of the movable barrier operator. As can be seen, the change to the characteristic is continuous (versus the discrete change as shown in the example of FIG. 4).

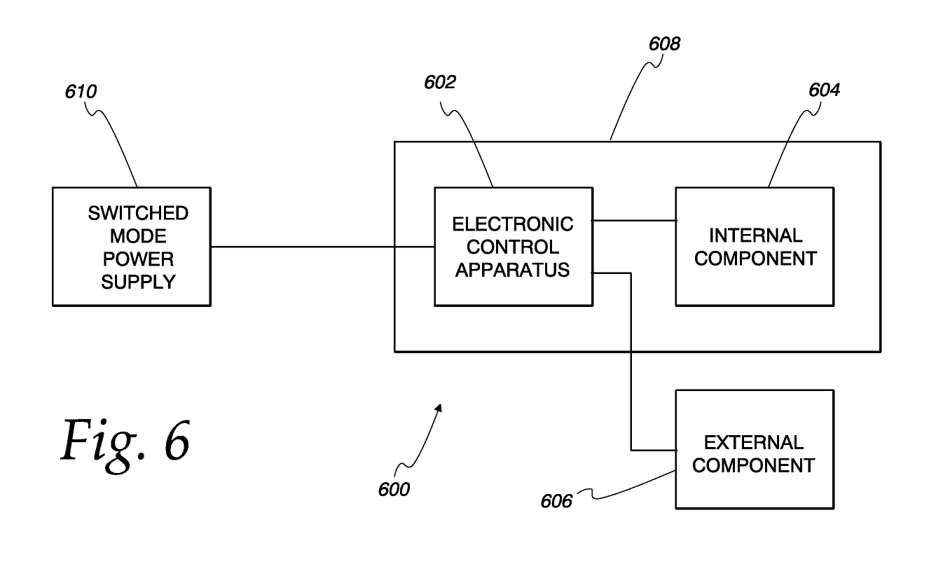

Referring now to FIG. 6, a movable barrier operator 600 includes an electronic control apparatus 602 and an internal component 604 and external component 606 (that is external to a housing 608 of the movable barrier operator 600).

In one example, the internal component 604 is coupled to and controlled by the electronic control apparatus 602 and may be a motor to name one example. The component may also be an electronic component (e.g., a microprocessor) of the electronic control apparatus 602 or some other electronic device within the movable barrier operator 600. In another example, the external component 606 is also coupled to and controlled by the electronic control apparatus and may be a sensing element, a switching element, a lighting element, or at least one electronic component, to name a few examples. Other examples of components are possible.

The operation of the components 604 or 606 draws a varying amount of a first electrical quantity from a switched mode power supply 610. The switched mode power 610 supply adjusts the varying amount of the first electrical quantity supplied to the movable barrier operator 600 based upon sensing changes in a second electrical quantity drawn by the component 604 or 606 from the switched mode power supply 610. The electrical quantities may be a wide variety of electrical quantities such as voltages, currents, or powers.

Thus, approaches are provided that system and method where the voltage and/or current supplied to a moveable barrier operator component such as a motor can be varied depending upon the operating characteristic or mode of operation of the motor (i.e., how much power is needed). For instance, when the motor is operating in an idle mode (e.g., the barrier is not being moved) the voltage (and/or current) being supplied by the power supply is less than in a mode where more voltage (and/or current) is required (e.g., the motor is running and being used to open or close a barrier). In so doing, the efficiency of the moveable barrier operator is increased as compared to previous systems, less voltage, current, and power are consumed, and barrier operator operational costs are reduced. The improved performance also increases user satisfaction with the system.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method of supplying a voltage to a component in a movable barrier operator system comprising:
supplying voltage to the component of the movable barrier operator system at an output of a switched mode power supply;
sensing a change in the current at the output of the switched mode power supply; and
changing a feedback ratio of the switched mode power supply based upon the sensed change in current, the changing of the feedback ratio altering the voltage presented at the output to the component of the movable barrier operator system.

2. The method of claim 1 wherein the component is selected from the group consisting of an operational mode device and an idle mode device.

3. The method of claim 2 wherein the operational mode device comprises an element selected from the group consisting of a motor, a switching element, a sensing element, and a lighting element.

4. The method of claim 2 wherein the idle mode device comprises an element selected from the group consisting of a thermometer, a clock, and an electronic component.

5. The method of claim 1 wherein the change in the current indicates that the movable barrier operator system is changing from a first mode of operation to a second mode of operation.

6. The method of claim 5 wherein the first mode of operation comprises an idle mode of operation.

7. The method of claim 6 wherein the second mode of operation comprises an operating mode wherein a motor is running.

8. A method of controlling the voltage in a moveable barrier operator system which comprises a switched mode power supply and a sensing circuit, comprising:
supplying a voltage to a component of the movable barrier operator system at an output of the switched mode power supply;
sensing a change in a current being supplied to the component of the movable barrier operator system at the sensing circuit;
responsively effectuating a change in the voltage being supplied at the output of the switched mode power supply to the component based at least in part upon the change in the current sensed by the sensing circuit.

9. The method of claim 8 wherein the component selected from the group consisting of an operational mode device and an idle mode device.

10. The method of claim 9 wherein the operational mode device comprises an element selected from the group consisting of a motor, a switching element, a sensing element, and a lighting element.

11. The method of claim 9 wherein the idle mode device comprises an element selected from the group consisting of a thermometer, a clock, and an electronic component.

12. The method of claim 8 wherein the change in the current indicates that the movable barrier operator system is changing from a first mode of operation to a second mode of operation.

13. The method of claim 12 wherein the first mode of operation comprises an idle mode of operation.

14. The method of claim 13 wherein the second mode of operation comprises an operating mode where a motor is running.

15. The method of claim 8 wherein effectuating a change in the voltage comprises changing a feedback ratio associated with the switched mode power supply.

16. The method of claim 8 wherein effectuating a change in the voltage comprises providing a first voltage when a first current is sensed and second voltage when a second current is sensed, the first voltage lower than the second voltage and the first current lower than the second current.

17. The method of claim 8 wherein sensing a change in the current comprises measuring a current over a plurality of resistors connected in parallel.

18. The method of claim 8 wherein sensing a change in the current comprises detecting an amount of a current drawn by the component and detecting when the detected amount of current drawn by the component falls below a predetermined threshold.

19. An apparatus for controlling the voltage in a moveable barrier operator system comprising:
a moveable barrier operator component;
a switched mode power supply coupled to the movable barrier operator component at an output of the switched mode power supply, the switched mode power supply configured to supply a voltage to the barrier operator component at the output;
a sensing circuit coupled to the switched mode supply and the movable barrier operator component, the sensing circuit configured to sense a change in a characteristic being supplied to the movable barrier operator component, the characteristic being selected from the group consisting of a current, a voltage, and a power, the sensing circuit configured to cause the switched mode power supply to effectuate a change in the voltage being supplied at the output based at least in part upon the change in the characteristic sensed by the sensing circuit.

20. The apparatus of claim 19 wherein the component selected from the group consisting of an operational mode device and an idle mode device.

21. The apparatus of claim 20 wherein the operational mode device comprises an element selected from the group consisting of a motor, a switching element, a sensing element, and a lighting element.

22. The apparatus of claim 20 wherein the idle mode device comprises an element selected from the group consisting of a thermometer, a clock, and an electronic component.

23. The apparatus of claim 19 wherein the sensing circuit comprises a plurality of resistors connected in parallel.

24. The apparatus of claim 19 wherein the switched mode power supply comprises at least one active component.

25. The apparatus of claim 19 wherein the change in the characteristic indicates a change in mode of operation of the movable barrier operator.

26. The apparatus of claim 19 wherein the sensing circuit comprises an element selected from the group consisting of at least one impedance element, an opto-isolator, a transistor, and an operational amplifier.

27. A movable barrier, operator comprising:
an electronic control apparatus;
an idle mode device;
an operational mode device that is coupled to and controlled by the electronic control apparatus, the operational mode device selected from the group consisting of a motor, a sensing element, a switching element, and a lighting element;
a switched mode power supply having a switch mode output and the switch mode output operatively coupled to the electronic control apparatus, the idle mode device, and the operational mode device, the switch mode power supply configured to supply a varying amount of an electrical quantity based upon sensing changes in the electrical quantity required by the idle mode device or the operational mode device from the switched mode power supply.

28. The operator of claim 27 wherein the idle mode device comprises an element selected from the group consisting of a thermometer, a clock, and an electronic component.

29. The operator of claim 27 wherein the idle mode device draws 0.5 amps of current or less.

30. The operator of claim 27 wherein the operational mode device draws 20 volts of voltage or more.

31. The operator of claim 27 wherein the operational mode device draws a current of 3 or more amps.

32. The operator of claim 27 wherein the electrical quantity is selected from the group consisting of a voltage, a current, and a power.
